(19) United States
(12) Patent Application Publication
(10) Pub. No.: US 2002/0143554 A1
(43) Pub. Date: Oct. 3, 2002

(54) Voice-activated control device for intelligent instruments

(76) Inventor: Shaw-Yuan Hou, Taipei (TW)

Correspondence Address: DOUGHERTY & TROXELL, SUITE 1404, 5205 LEESBURG PIKE, FALLS CHURCH, VA, 22041, US

(21) Appl. No.: 09/802,940

(22) Filed: Mar. 12, 2001

(51) Int. Cl. G10L 21/00

(52) U.S. Cl. 704/275

(57) ABSTRACT

A voice-activated control device is proposed for use with an intelligent instrument, such as an intelligent oscilloscope, of the type having an external communication port, such as IEEE-488 or RS-232 compliant communication port, to allow a user to control the operations of the intelligent instrument through voice activation. The proposed voice-activated control device can be either implemented as an externally-coupled module box which can be externally coupled between an intelligent instrument and a computer system, or as a soft-ware program loaded in a computer system having a compliant communication interface and a digital voice processing module. The proposed voice-activated control device allows the user to control the operations of the intelligent instrument simply by uttering a voice command, and the voice-activated control device will be automatically activated to send out the corresponding command code via the IEEE-488 or RS-232 communication link to the intelligent instrument to cause the intelligent instrument to operate accordingly.

### BACKGROUND OF THE INVENTION

1. Field of the Invention:

This invention relates to voice control technology, and more particularly, to a voice-activated control device which is specifically designed for use with an intelligent instrument having an external communication interface, such as an intelligent oscilloscope with IEEE488 or RS-232, for the purpose of allowing the user to control the operations of the intelligent instrument through voice activation.

2. Description of Related Art:

Laboratory and factory instruments, such as oscilloscopes, process monitors, machine controllers, and the like, are typically provided with a control panel that allows the technician to control the operations of these instruments by manually pressing the buttons or switches thereon. In order to allow computerized process control, these instruments are usually provided with an external communication port, such as IEEE488 or RS-232 port, for external connection to a computer system, such as,a workstation or mainframe, whereby the operations of the instruments can be controlled through programed procedures.

By computerized control, the user can first use the computer system to write a set of command codes representative of a sequence of operations that the user wants the instrument to perform, and then store the command-code set in the memory of the computer system. Thereafter, the user can simple activate the computer system to transfer the command-code set via IEEE-488 or RS-232 communication interface to the instrument to cause it to operate accordingly.

The advantage of using the computerized control is that it can eliminate the need to manually press buttons on the control panel repeatedly, which is quite laborious and time-consuming for the user, so that it can make the operation of the instrument more conveniently and efficiently.

One drawback to the forgoing computerized control, however, is that it nevertheless requires the user to manually operate the computer for activating the transfer of the command-code set to the instrument being controlled. In many circumstances, for example, when the user is operating an oscilloscope with both hands holding test probes, it would be highly inconvenient for the user to manually operate point device or keyboard of the computer system.

There exists therefore a need in the market for a voice-activated control device that can be externally coupled to an intelligent instrument to allow the user to control the operations of the intelligent instrument through voice activation.

### SUMMARY OF THE INVENTION

It is therefore an objective of this invention to provide a voice-activated control device for use with an intelligent instrument to allow the user to control the operations of the intelligent instrument through voice activation without having to use hands.

In accordance with the foregoing and other objectives, the invention proposes a novel voice-activated control device for intelligent instruments.

The voice-activated control device according to the invention comprises: (a) a communication interface for external coupling with the communication port of the intelligent instrument; (b) a voice input unit, which is capable of picking up the user's voice command, if any, and converting it to an analog voice signal; (c) a voice signal conversion unit, which is capable of converting the output analog voice signal from the voice input unit into a digital voice signal; (d) a voice recognition unit, which is capable of performing a voice recognition algorithm on the output digital voice signal from the voice signal conversion unit to thereby producing a voice key representative of the user's voice command; (e) a command-code database for storing a predefined set of command codes specific to the intelligent instrument; and (f) a data acquisition unit, which is capable of searching through the command-code database to find a command code corresponding to the output voice key from the voice recognition unit, and further capable of transferring the retrieved command code via the communication interface to the intelligent instrument to cause the intelligent instrument to perform a function specific to the command code.

The voice-activated control device of the invention can be either implemented as an externally-coupled module box which can be externally coupled between an intelligent instrument and a computer system, or as a software program loaded in a computer system having a compliant communication interface and a digital voice processing module.

The voice-activated control device of the invention allows the user to control the operations of the intelligent instrument simply by uttering a voice command, and the voice-activated control device of the invention will be automatically activated to send out the corresponding command code via the IEEE488 or RS-232 communication link to the intelligent instrument to cause the intelligent instrument to operate accordingly.

### BRIEF DESCRIPTION OF DRAWINGS

The invention can be more fully understood by reading the following detailed description of the preferred embodiments, with reference made to the accompanying drawings, wherein:

FIG. 1A is a schematic diagram showing the coupling of a first preferred embodiment of the voice-activated control device of the invention between an intelligent instrument and a computer system;

FIG. 1B is a schematic diagram showing the external coupling of the first preferred embodiment of the voice-activated control device of the invention to an intelligent instrument;

FIG. 1C is a schematic block diagram showing the system architecture of the first preferred embodiment of the voice-activated control device of the invention;

FIG. 2A is a schematic diagram showing the coupling of an intelligent instrument to a computer system used to implement the voice-activated control device of the invention;

FIG. 2B is a schematic block diagram showing the system architecture of the second preferred embodiment of the voice-activated control device of the invention in the case of being implemented through software.

### DETAILED DESCRIPTION OF PREFERRED EMBODIMENTS

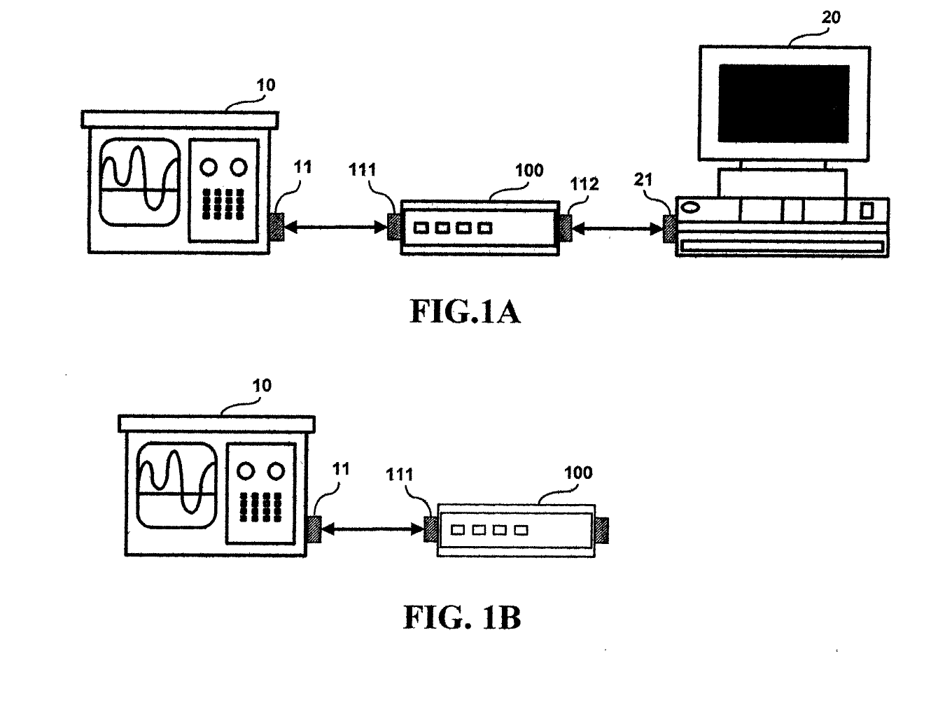

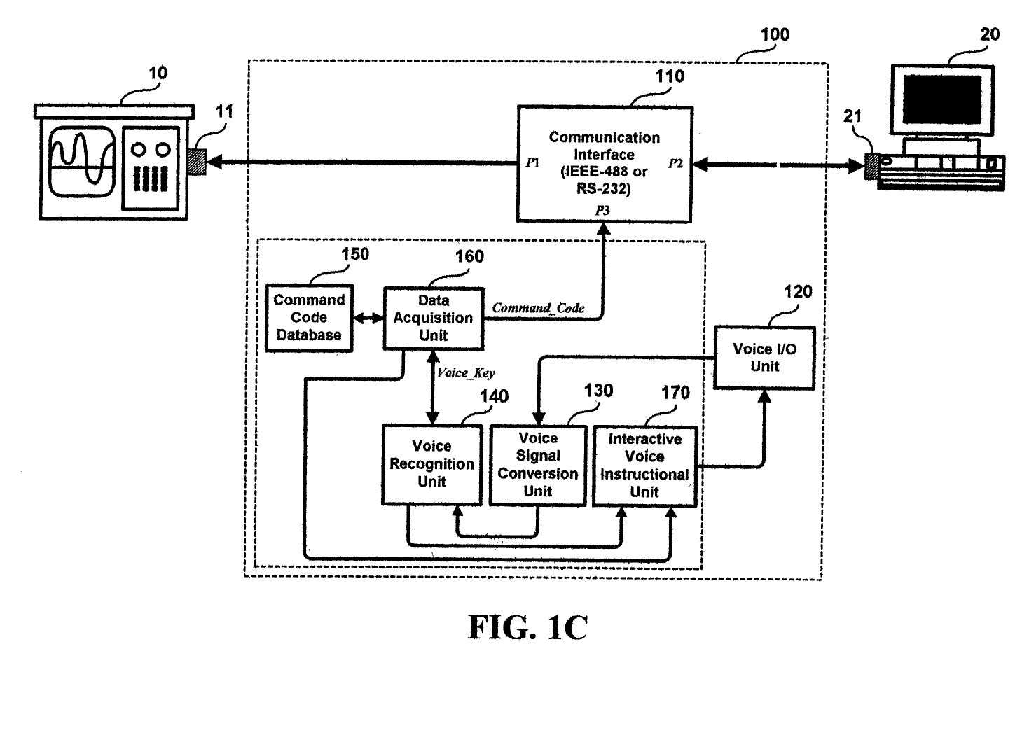

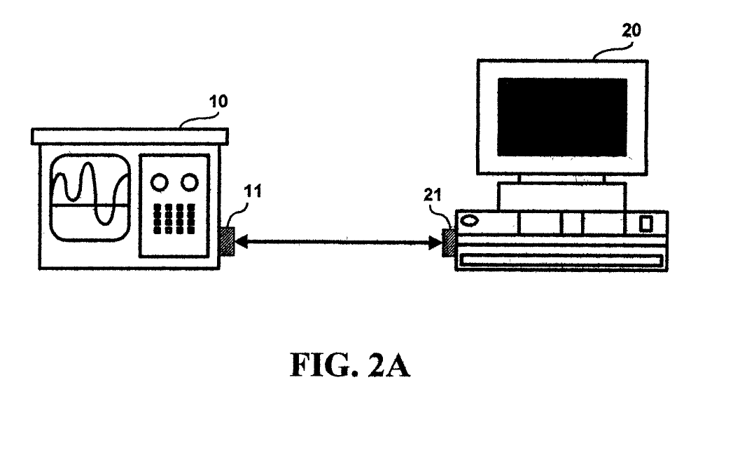

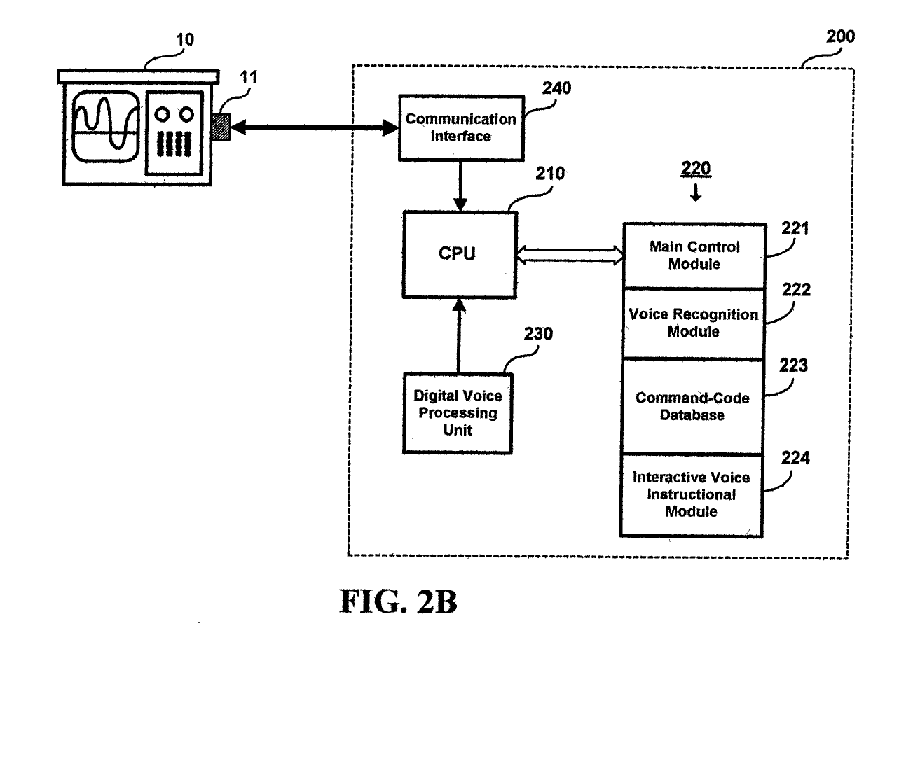

The voice-activated control device of the invention is disclosed in full details by way of two preferred embodiments in the following with reference to FIGs. 1A-1C and FIGS. 2A-2B, respectively.

### FIRST PREFERRED EMBODIMENT (FIGs. 1A-1C)

The first preferred embodiment of the voice-activated control device of the invention is disclosed in full details in the following with reference to FIGs. 1A-1C.

Referring first to FIG. 1A, by the first preferred embodiment, the voice-activated control device of the invention is implemented as an externally-coupled module box (designated by the reference numeral 100) which can be externally coupled between an intelligent instrument 10, such as an intelligent oscilloscope, and a computer system 20, such as a personal computer or workstation. The intelligent instrument 10 should be the type having an external communication port 11, such as IEEE488 or RS-232 port; and the computer system 20 is also provided with a compliant communication port 21. Correspondingly, the voice-activated control device 100 is provided with two compliant communication ports, a first communication port 111 for connection to the communication port 11 of the intelligent instrument 10 and a second communication port 112 for connection to the communication port 21 of the computer system 20. The voice-activated control device 100 allows the user to utter a voice command representative of the intended operation of the intelligent instrument 10, and the voice-activated control device 100 will be automatically activated to send out the corresponding command code to the intelligent instrument 10 to cause the intelligent instrument 10 to operate accordingly.

In the case of the intelligent instrument 10 being an oscilloscope, for example, assume the user wants to adjust the oscilloscope 10 to display waveforms in 10 μs (micrometer) time scale, he/she needs just to utter, for example, the voice command “TIME SCALE 10MICROSECOND”, and the voice-activated control device 100 will be automatically activated to send out the corresponding command code to the oscilloscope 10 to cause the oscilloscope 10 to perform the requested adjustment. In order to allow the voice-activated control device 100 to be completely voice-operated without requiring manual operation, the voice-activated control device 100 is initiated by an initialization voice command, such as “OSCILLOSCOPE”.

The voice-activated control device 100 can be prestored with all the command codes from various types of intelligent instruments, so that the voice-activated control device 100 can be used to control the operations of these various types of intelligent instruments. In addition, the manufacturer can establish an Internet server that allows the user to download the command-code set of any new intelligent instrument via the computer system 20 to the voice-activated control device 100.

Referring next to FIG. 1B, after a new command-code set is downloaded via the computer system 20, the voice-activated control device 100 can be detached from the computer system 20 and operate independently. Thereafter, the user needs just to utter a voice command representative of the intended operation of the intelligent instrument 10, and the voice-activated control device 100 will be automatically activated to send out the corresponding command code to the intelligent instrument 10 to cause the intelligent instrument 10 to operate accordingly.

FIG. 1C is a schematic block diagram showing the system architecture of the first preferred embodiment of the voice-activated control device 100 of the invention. As shown, the voice-activated control device 100 includes a communication interface 110, a voice input/output unit 120, a voice signal conversion unit 130, a voice recognition unit 140, a command-code database 150, a data acquisition unit 160, and an interactive voice instructional unit 170.

The communication interface 110 includes a first I/O port P1, a second I/O port P2, and a third I/O port P3; wherein the first I/O port P1 serves as the above-mentioned first communication port 111 for external connection to the communication port 11 of the intelligent instrument 10; the second I/O port P2 serves as the above-mentioned second communication port 112 for external connection to the communication port 21 of the computer system 20; and the third I/O port P3 is internally coupled to the data acquisition unit 160.

The voice input/output unit 120 is a microphone/loudspeaker module, which is capable of picking up the user's natural voice command and convert it to an analog voice signal, and is further capable of broadcasting the output voice instructions from the interactive voice instructional unit 170.

The voice signal conversion unit 130 is a conventional analog-to-digital converter, which is capable of converting the output analog voice signal from the voice input/output unit 120 into a digital voice signal.

The voice recognition unit 140 is capable of performing a voice recognition algorithm on the output digital voice signal from the voice signal conversion unit 130 to thereby recognize the user's voice command. The voice recognition unit 140 can be either a dedicated chip or a microprocessor with voice-recognition firmware. The voice recognition algorithm performed by the voice recognition unit 140 can be either speaker-dependent or speaker-independent. By the speaker-dependent technology, the user needs to train the voice-activated control device 100 to learn the user's voice commands and link them to their corresponding command codes. By the speaker-independent technology, the voice commands are factory-built into the voice-activated control device 100, so that the user dosen't need to train the voice-activated control device 100 before use. The speaker-dependent and speaker-independent schemes are all conventional and well-known technologies, so description thereof will not be further detailed.

The command-code database 150 is a data storage unit, such as flash memory, which is used to store one or more predefined set of command codes specific to one or more types of intelligent instruments. These command codes are each mapped to a unique voice key representative of a particular command code. These command codes can be factory-built into the command-code database 150 or downloaded via the computer system 20 from a remote network server, such as an Internet server.

The data acquisition unit 160 can be either a microcontroller or a specific-purpose logic circuit, which is coupled to the communication interface 110 the voice recognition unit 140, and the command-code database 150 to control their operations.

The interactive voice instructional unit 170 is used to store a predefined set of voice instructions which will be interactively broadcast to the user while he/she is operating the voice-activated control device 100. These voice instructions can be, for example, “INPUT ERROR, PLEASE TRY AGAIN”, “EXECUTION COMPLETED”, and so on. The output of the interactive voice instructional unit 170 is coupled to the voice input/output unit 120 where the voice instructions can be reproduced and broadcast to the user.

The voice-activated control device 100 of the invention allows the user to control the operations of the intelligent instrument 10 simply by uttering a voice command, and the voice-activated control device 100 of the invention will be automatically activated to send out the corresponding command code via the IEEE488 or RS-232 communication link to the intelligent instrument 10 to cause the intelligent instrument 10 to operate accordingly.

When a voice command is issued, it can be picked up by the voice input/output unit 120 and converted into an analog voice signal. The voice signal conversion unit 130 then converts the output analog voice signal from the voice input/output unit 120 into a digital voice signal and then transfers it to the voice recognition unit 140 for recognition.

The voice recognition unit 140 can perform a voice recognition algorithm on the digital voice signal from the voice signal conversion unit 120 to thereby recognize the user's voice command. If the recognition is successful, the voice recognition unit 140 will generate a binary voice key VOICE_KEY representative of the recognized voice command and send VOICE_KEY to the data acquisition unit 160. Otherwise, if the voice recognition is unsuccessful, the data acquisition unit 160 will send a notifying signal to the interactive voice instructional unit 170 to cause the interactive voice instructional unit 170 to output a voice message, such as “RECOGNITION FAILED, PLEASE TRY AGAIN”, to the user.

Based on VOICE_KEY from the voice recognition unit 140, the data acquisition unit 160 will perform a search through the command-code database 150 to retrieve the corresponding command code (represented by COMMAND_CODE) from the command-code database 150 and then transfers it via the communication interface 110 to the intelligent instrument 10 to cause the intelligent instrument 10 to perform the function specified by COMMAND_CODE.

### SECOND PREFERRED EMBODIMENT (FIGS. 2A-2B)

The second preferred embodiment of the voice-activated control device of the invention is disclosed in full details in the following with reference to FIGS. 2A-2B.

Referring to FIG. 2A, by this embodiment, the voice-activated control device of the invention is implemented as a software program loaded in a computer system 20 having an external communication port 21, such as IEEE488 or RS-232 port, and is used to allow the user to voice control the operations of an intelligent instrument 10 having a compliant external communication port 11.

Referring further to FIG. 2B, the computer system 20 should include a CPU 210, a main memory unit 220, a digital voice processing unit 230, and a communication interface 240. The digital voice processing unit 230 can be, for example, a sound card with microphone/loudspeaker module and digital sound functionality.

By the second preferred embodiment, the voice-activated control device of the invention is implemented as a software program loaded in the main memory unit 220, which includes a main control module 221, a voice recognition module 222, a command-code database 223, and an interactive voice instructional module 224.

The above-mentioned constituent components of the second preferred embodiment are functionally equivalent to the constituent components of the first preferred embodiment as indicated by the following table.

| Constituent Components of | Functionally-equivalent Component(s) |
|---|---|
| the First Preferred Embodiment | in the Second Preferred Embodiment |
| communication interface 110 | communication interface 240 |
| voice input/output unit 120 | digital voice processing unit 230 |
| voice signal conversion unit 130 | digital voice processing unit 230 |
| voice recognition unit 140 | voice recognition module 222 |
| command-code database 150 | command-code database 223 |
| data acquisition unit 160 | main control module 221 plus CPU 210 |
| interactive voice instructional | interactive voice instructional |
| unit 170 | module 224 |

Therefore, the second preferred embodiment is entirely functionally equivalent to the first preferred embodiment, which allows the user to control the operations of the intelligent instrument 10 simply by uttering a voice command toward the microphone module (not shown) of the digital voice processing unit 230.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A voice-activated control device for use with an intelligent instrument of the type having an external communication port to allow a user to control the operations of the intelligent instrument through voice activation;
the voice-activated control device comprising:
(a) a communication interface for external coupling with the communication port of the intelligent instrument;
(b) a voice input unit, which is capable of picking up the user's voice command, if any, and converting it to an analog voice signal;
(c) a voice signal conversion unit, which is capable of converting the output analog voice signal from the voice input unit into a digital voice signal;
(d) a voice recognition unit, which is capable of performing a voice recognition algorithm on the output digital voice signal from the voice signal conversion unit to thereby producing a voice key representative of the user's voice command;
(e) a command-code database for storing a predefined set of command codes specific to the intelligent instrument; and
(f) a data acquisition unit, which is capable of searching through the command-code database to find a command code corresponding to the output voice key from the voice recognition unit, and further capable of transferring the retrieved command code via the communication interface to the intelligent instrument to cause the intelligent instrument to perform a function specific to the command code.

2. The voice-activated control device of claim 1, wherein the external communication port of the intelligent instrument is IEEE488 compliant.

3. The voice-activated control device of claim 1, wherein the external communication port of the intelligent instrument is RS-232 compliant.

4. The voice-activated control device of claim 1, further comprising:
an interactive voice instructional unit which stores a predefined set of voice instructions

5. The voice-activated control device of claim 1, wherein the intelligent instrument is an oscilloscope.

6. The voice-activated control device of claim 1, which is implemented as an individual module box to be coupled between the intelligent instrument and a computer system.

7. The voice-activated control device of claim 6, wherein the communication interface includes:
a first I/O port for external coupling to the communication port of the intelligent instrument;
a second I/O port for external coupling to the computer system; and
a third I/O port for internal coupling to the data acquisition unit.

8. The voice-activated control device of claim 7, wherein the command codes stored in the command-code database are downloaded via the computer system from an Internet server.

9. The voice-activated control device of claim 1, which is implemented as a software program loaded in a computer system having a CPU, a main memory unit, a digital voice processing unit, and a communication interface compliant to the communication port of the intelligent instrument; and wherein the computer system is directly linked to the intelligent instrument via the communication interface.
